(19) United States
(12) Patent Application Publication
(10) Pub. No.: US 2008/0257050 A1
(43) Pub. Date: Oct. 23, 2008

(54) Ultrasonic sensor

(75) Inventor: Kazuaki Watanabe, Nagoya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/905,873

(22) Filed: Oct. 5, 2007

(30) Foreign Application Priority Data
Oct. 13, 2006 (JP) 2006-280020

(51) Int. Cl. G01N 29/04; G01K 13/00

(52) U.S. Cl. 73/627; 374/142; 374/E13.001

(57) ABSTRACT

An ultrasonic sensor for sending and receiving an ultrasonic wave, the ultrasonic sensor includes: an ultrasonic transducer; and a Peltier element having a thermoelectric element, a first electrode, a first substrate and a second substrate. The thermoelectric element is coupled with the first electrode. The thermoelectric element and the first electrode are disposed between the first substrate and the second substrate. The ultrasonic transducer is disposed on the first substrate. The ultrasonic transducer sends and receives the ultrasonic wave in accordance with a vibration of the ultrasonic transducer.

### CROSS REFERENCE TO RELATED APPLICATION

This application is based on Japanese Patent Application No. 2006-280020 filed on Oct. 13, 2006, the disclosure of which is incorporated herein by reference.

### FIELD OF THE INVENTION

The present invention relates to an ultrasonic sensor for sending and receiving an ultrasonic wave.

### BACKGROUND OF THE INVENTION

A conventional ultrasonic sensor includes an ultrasonic transducer that is bonded to a substrate made from material such as metal and resin. The ultrasonic sensor sends an ultrasonic wave to an object and receives the ultrasonic wave reflected by the object. The ultrasonic sensor is, for example, mounted to a vehicle. The ultrasonic wave sent and received by the sensor provides information on the object around the vehicle, such as the location of the object, the distance between the sensor and the object, the two-dimensional shape of the object and the three dimensional shape of the object.

JP-2002-58097 shows following ultrasonic sensor. The ultrasonic sensor includes a substrate that is attached to a circular cylinder shaped aluminum case. The substrate is directly fixed to a piezoelectric ultrasonic transducer that detects the ultrasonic wave. The vibration of the substrate causes the sending and receiving of the ultrasonic wave.

When a high voltage is applied to the ultrasonic sensor so that the outputs from the piezoelectric ultrasonic transducer increases, the temperature of the transducer is increased by a large heat produced in the piezoelectric ultrasonic transducer. When the temperature of the transducer exceeds half of its Curie temperature, the polarization degree of the piezoelectric body decreases rapidly as the temperature increases. It is necessary to control the temperature not to exceed a predetermined temperature. The conventional ultrasonic sensors therefore have the problems that there are an upper limit of the voltage applied to the ultrasonic sensor, and an upper limit of the outputs from the ultrasonic sensor. Further there is a problem that the ultrasonic sensor properties are changed together with temperature. Moreover, since the ultrasonic sensor is attached to an exposed place of an apparatus, it is required for the ultrasonic sensor to downsize its dimension in order to avoid spoil of the beauty of the appearance. Furthermore, another problem is that the sensor would have a large body when the sensor has a cooling means for highly cooling the transducer. Thus, it is required for an ultrasonic sensor to improve cooling performance and minimize its dimension.

### SUMMARY OF THE INVENTION

In view of the above-described problem, it is an object of the present disclosure to provide an ultrasonic sensor.

According to a first aspect of the present disclosure, an ultrasonic sensor for sending and receiving an ultrasonic wave, the ultrasonic sensor includes: an ultrasonic transducer; and a Peltier element including a thermoelectric element, a first electrode, a first substrate and a second substrate. The thermoelectric element is coupled with the first electrode. The thermoelectric element and the first electrode are disposed between the first substrate and the second substrate. The ultrasonic transducer is disposed on the first substrate. The ultrasonic transducer sends and receives the ultrasonic wave in accordance with a vibration of the ultrasonic transducer.

According to the above ultrasonic sensor, the ultrasonic transducer is cooled by the Peltier element having a high cooling capacity. Stable sensing is realized by the suppressing of the temperature increase of the ultrasonic transducer.

According to a second aspect of the present disclosure, an ultrasonic sensor for sending and receiving an ultrasonic wave, the ultrasonic sensor includes: an ultrasonic transducer; a Peltier element including a thermoelectric element, a first electrode, a first substrate and the second substrate; and a heat release element. The first substrate has a first opening at a predetermined portion. The thermoelectric element is coupled with the first electrode. The first electrode and the thermoelectric element are disposed between the first substrate except the first opening and the second substrate. The first substrate has a third surface. The third surface is opposite to the thermoelectric element. The heat release element is disposed on the third surface of the first substrate. The heat release element has a fourth surface, on which the first surface is disposed on. The ultrasonic transducer is disposed on the fourth surface of the heat release element, and disposed in the first opening of the first substrate. The ultrasonic transducer sends and receives the ultrasonic wave. The heat release element absorbs heat generated in the ultrasonic transducer.

According to the above ultrasonic sensor, the heat generated in the ultrasonic transducer is transferred to the Peltier element. The Peltier element causes the heat to radiate. The cooling performance of the ultrasonic sensor is improved.

### BRIEF DESCRIPTION OF THE DRAWINGS

The above and other objects, features and advantages of the present invention will become more apparent from the following detailed description made with reference to the accompanying drawings. In the drawings:

FIG. 1A illustrates a plan view of an ultrasonic sensor viewing from the side of an ultrasonic transducer, according to a first embodiment;

FIG. 1B is a cross sectional view of the ultrasonic sensor taken along line I B-I B in FIG. 1A;

FIG. 2 is a cross sectional view of the ultrasonic sensor for explaining a method for mounting the sensor, according to a modification of the first embodiment;

FIG. 3 is a cross sectional view of the ultrasonic sensor for explaining another method for mounting the sensor, according to another modification of the first embodiment;

FIG. 4 is a cross sectional view of an ultrasonic sensor that includes a temperature control element;

FIG. 5A is a cross sectional view of an ultrasonic sensor having an ultrasonic transducer according to a second embodiment, the sensor disposed on an outer side of a Peltier element;

FIG. 5B is a cross sectional view of the ultrasonic sensor having an ultrasonic transducer disposed on an inner side of a Peltier element, according to a modification of the second embodiment;

FIG. 6A is a cross sectional view of an ultrasonic sensor having an ultrasonic transducer disposed on an inner side of a vehicle, according to a third embodiment;

FIG. 6B is a cross sectional view of the ultrasonic sensor having an ultrasonic transducer disposed on an outer side of a vehicle, according to a modification of the third embodiment;

FIG. 7 is a cross sectional view of an ultrasonic sensor, according to another modification of the third embodiment.

FIGS. 8A and 8B are cross sectional views of ultrasonic sensors, in each of which a heat release element is disposed on a surface of a cooling side substrate;

FIG. 9 is a cross sectional view of an ultrasonic sensor in which the ultrasonic transducer is disposed on a surface of a heat release element; and

FIG. 10 is a schematic view of a vehicle for explaining vehicle parts, at least one of the parts to which an ultrasonic sensor is mounted.

### DETAILED DESCRIPTION OF THE PREFERRED EMBODIMENTS

### First Embodiment

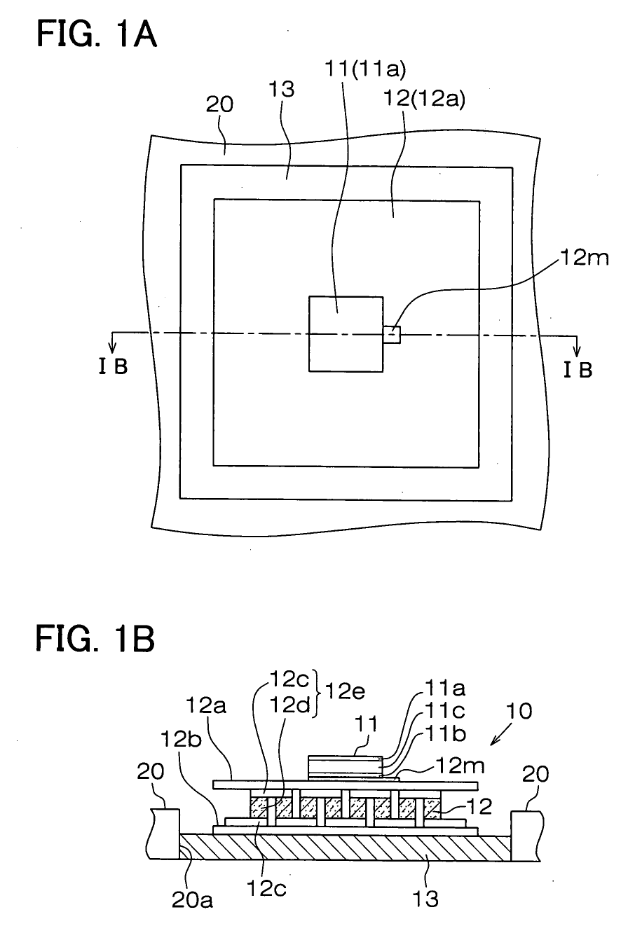

FIGS. 1A to 4 are explanatory diagrams of ultrasonic sensors according to a first embodiment.

An ultrasonic sensor 10 includes an ultrasonic transducer 11, a Peltier element 12 and a heat release element 13, as shown in FIGS. 1A and 1B. The ultrasonic transducer 11 generates and detects an ultrasonic wave. The ultrasonic transducer 11 is disposed on a surface of a cooling side substrate 12a of the Peltier element 12, the surface which is disposed on an outer surface of the Peltier element 12. The heat release element 13 is disposed on a surface of a heat release side substrate 12b of the Peltier element 12, the surface which is disposed on another outer surface of the Peltier element 12.

The ultrasonic transducer 11 includes a piezoelectric element 11c, a top electrode 11a and a bottom electrode 11b. The piezoelectric element 11c is disposed between the top electrode 11a and the bottom electrode 11b. Material of the piezoelectric element 11c is, for example, lead zirconate titanate (PZT). The ultrasonic transducer is disposed on a central region of the cooling side substrate 12a of the Peltier element 12. The second electrode 12m is disposed on the cooling side substrate 12a of the Peltier element 12. The second electrode 12m is thin plating. The bottom electrode 11b is connected to a second electrode 12m via an electrically conductive material such as a conductive adhesive. This reduces manufacturing cost because it is possible to manufacture a first electrode 12c and the second electrode 12m at the same time. The second electrode 12m is an element for inputting a voltage signal into the ultrasonic transducer 11, and for outputting a voltage signal from the ultrasonic transducer 11. The first electrode 12c is the electrode of the Peltier element 12. More detail explanation on the first electrode 12c is given later.

Since the lead zirconate titanate (PZT) has a large piezoelectric constant, the ultrasonic sensor can send an intense ultrasonic wave and receive a faint ultrasonic wave. Thus, the sensor has excellent sensitivity.

The Peltier element 12 includes a thermoelectric member 12e, the cooling side substrate 12a and the heat release side substrate 12b. The thermoelectric member 12e is disposed between the cooling side substrate 12a and the heat release side substrate 12b. The thermoelectric member 12e includes a thermoelectric element 12d and the first electrode 12c. The thermoelectric member 12e is structured in such a way that P-type and N-type thermoelectric elements 12d are arranged alternatively in series through the first electrodes 12c. An electrode plane of the first electrode 12c is disposed between the cooling side substrate 12a and the heat release side substrate 12b. The first electrode 12c is electronically connected to a drive circuit (which is not shown). The drive circuit supplies an electric current to the Peltier element 12 so that the heat around the cooling side substrate 12a is transferred to the heat release side substrate 12b.

The heat release element 13 fully contacts with the heat release side substrate 12b of the Peltier element 12. Material of the heat release element 13 may be high heat conductive material, which is, for example, metal (e.g., aluminum) and carbonaceous matter. The heat release element 13 efficiently radiates the heat to environment, the heat which is generated in the ultrasonic transducer 11 and then transferred to the heat release side substrate 12b from the cooling side substrate 12a. The heat release element 13 improves cooling efficiency of the ultrasonic transducer 11.

The ultrasonic sensor 10 is mounted to a fixing portion 20a of a bumper 20 of a vehicle 60. A side of the ultrasonic transducer 11 is set toward the vehicle internal side. The heat release element 13 is exposed to the outside of the vehicle 60. In this configuration, the ultrasonic transducer 11 is not exposed to an outside of the vehicle. Thus the ultrasonic transducer 11 is protected against a foreign body such as a small stone and a droplet.

The ultrasonic transducer 11 generates the ultrasonic wave. The ultrasonic sensor 10 sends the ultrasonic wave to the outside of the vehicle 60 through the Peltier element 12 and the heat release element 13. The ultrasonic wave is reflected by an obstacle, and then received by the ultrasonic transducer 11 via the Peltier element 12 and the heat release element 13. The received ultrasonic wave is converted into a voltage signal in the ultrasonic transducer 11.

A circuit (which is not shown), which is electronically connected to the ultrasonic transducer 11, is electronically connected to ECU. The circuit executes an arithmetic processing based on the signal output from the ultrasonic transducer 11. The distance between the obstacle and the vehicle is, for example, measured by determining the time-lag or the phase-difference between the ultrasonic waves sent and received by the ultrasonic sensor. An alternative ultrasonic sensor may include an ultrasonic transducer only for receiving the ultrasonic wave and an ultrasonic sending element for sending the ultrasonic wave to the obstacle.

Since the ultrasonic sensor 10 according to the first embodiment has the configuration as mentioned above, the ultrasonic transducer 11 is cooled by the Peltier element 12 having a high cooling capacity. Thus stable sensing is realized by the suppressing of the temperature increase of the ultrasonic sensor 10. Since the ultrasonic transducer 11 is disposed on the cooling side substrate 12a of the Peltier element 12, an additional substrate other than the cooling side substrate 12a is not required, the additional substrate which is an element for supporting the ultrasonic transducer 11. Therefore the ultrasonic sensor 10 is downsized.

### First Modification of the First Embodiment

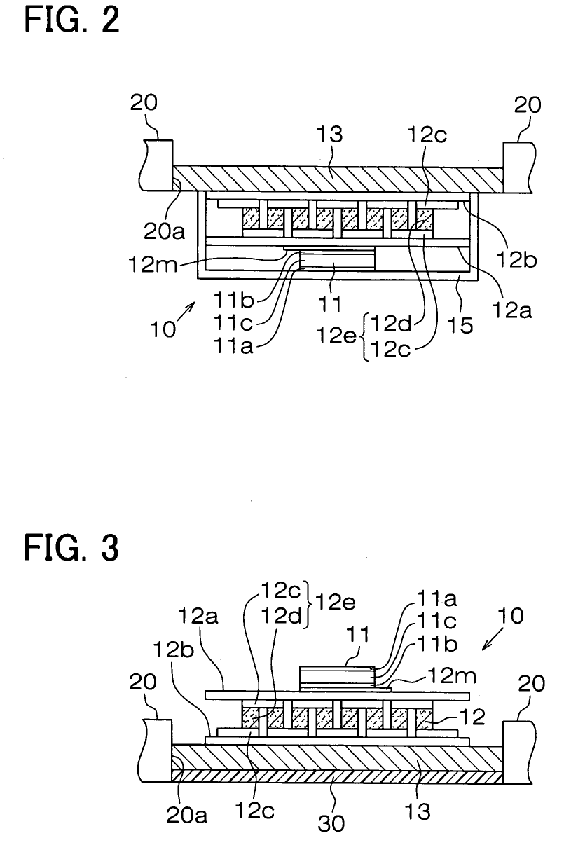

As shown in FIG. 2, the ultrasonic sensor 10 is connected to the bumper 20 in such a manner that the ultrasonic transducer 11 is set toward the outside of the vehicle 60. A cover 15 and the Peltier element 12 are disposed on the heat release element 13. The cover 15 covers the ultrasonic transducer 11

In this configuration, the ultrasonic transducer is set toward the outside of the vehicle 60. Since the ultrasonic wave is transmitted to the ultrasonic transducer 11 without involving the Peltier element 12 and the heat release element 13, the detection sensitivity to the ultrasonic wave is improved.

The cover 15 may include a structure such as a mesh and through-holes therein in order not to prevent the transmission of the ultrasonic wave as far as possible. Note that it is unnecessary to dispose the cover 15 when the ultrasonic sensor is attached to an apparatus for indoor use such as a robot.

### Second Modification of the First Embodiment

A configuration of an ultrasonic sensor, as shown in FIG. 3, is alternative configuration. A protector 30 is disposed on a surface of the heat release element 13, the surface which is disposed on an outer side of the bumper 20. The protector 30 has a plate shape. Color tone of the support 30 is similar to that of the bumper 20. In this configuration, the ultrasonic sensor 10 becomes unnoticeable. Therefore the ultrasonic sensor 1 can have decent design, and keep the beauty of the bumper 20.

The protector 30 is, for example, made from polycarbonate resin, which may be similar material to the bumper 20. The protector 30 is bonded to the heat release element 13 having a plate shape. Alternatively, the protector 30 may be formed by hardening fluid resin after the fluid resin is applied to the heat release element 13.

### Third Modification of the First Embodiment

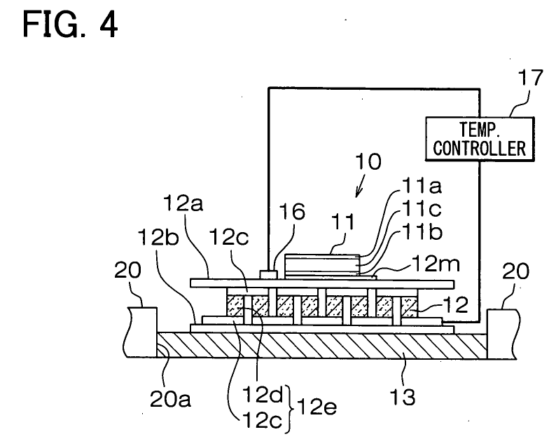

An ultrasonic sensor according to a third modification of the first embodiment further includes a temperature detection element and a temperature control element (cf., temp. controller in FIG. 4). The temperature detection element measures a temperature of the ultrasonic transducer 11. The temperature control element controls a temperature of the ultrasonic transducer 11 in such a way that the temperature control element 17 controls an electric power supplied to the Peltier element 12 based on a signal output from the temperature detection element 17.

FIG. 4 shows an example configuration of the ultrasonic sensor. A thermistor 16 is disposed on the cooling side substrate 12a and is located next to the ultrasonic transducer 11. The thermistor 16 measures the temperature of the ultrasonic transducer 11. Based on a signal from the thermistor 16, the temperature control element 17 controls an drive current to be supplied to the Peltier element 12 from the first electrode 12c. The ultrasonic transducer 11 can be in an appropriate temperature range.

In this configuration, the temperature of the ultrasonic transducer 11 is controlled so that the temperature is in a predetermined temperature ranges. The properties of the ultrasonic transducer 11 have small temperature dependency. The detection sensitivity to the ultrasonic wave is improved.

An element other than the thermistor 16 may be used for the temperature detection element. An example of the element is a thermocouple. The thermocouple may be disposed on any element or place as long as the temperature of the ultrasonic transducer 11 is correlated with the temperature detected by the thermocouple. The place to which the thermocouple is mounted is, for example, a surface of the top electrode 11a or inside of the heat release element 13.

Each of the ultrasonic transducer 11, the Peltier element 12 and the heat release element 13 according to the first embodiment has, for example, the rectangular plate shape. Alternatively, these elements have other shapes. For example, they have a circular disk shape.

The ultrasonic sensor according to the first embodiment includes following advantages.

(1) The ultrasonic sensor 10 includes the Peltier element 12 and the ultrasonic transducer 11. Since the ultrasonic transducer 11, which sends and receives the ultrasonic wave, is disposed on the cooling side substrate 12a of the Peltier element 12, the ultrasonic transducer 11 is cooled by the Peltier element 12 having high cooling capacity. The suppressing of the temperature increase of the ultrasonic transducer 11 realizes stable operation of the ultrasonic sensor 10. In addition to the stable operation, the downsizing of the ultrasonic sensor 10 is also realized. This is because the ultrasonic transducer 11 is disposed on the cooling side substrate 12a of the Peltier element 12, and further an additional substrate other than the cooling side substrate 12a is not required, the additional substrate which is used for supporting the ultrasonic transducer 11. The ultrasonic sensor 10 stably operates.

(2) The heat release element is disposed on a surface of the heat release side substrate 12b, the surface which is disposed on an outer side the Peltier element 12. The heat generated in the ultrasonic transducer 11 is transferred from the cooling side substrate 12a to the heat release side substrate 12b due to the function of the Peltier element 12. The heat in the heat release side substrate 12b is transferred to the heat release element 13. The heat generated in the ultrasonic transducer 11 is efficiently radiated to the environment through the Peltier element 12 and the heat release element 13. The cooling power for cooling the ultrasonic transducer 11 is improved.

(3) The second electrode 12m, which is electrically connected to the ultrasonic transducer 11, is formed on the cooling side substrate. The first electrode 12c is connected to the thermoelectric element 12e. The first electrode 12c and the second electrode 12m may be formed in the same process, and thereby the manufacturing process of the electrodes 12c, 12m may be reduced.

(4) The ultrasonic sensor includes the thermistor 16 and the temperature control element 17. The themistor 16 measures the temperature of the ultrasonic transducer 11. The temperature control element 17 controls the temperature of the ultrasonic transducer 11 based on a temperature signal output from the thermistor 16. The temperature signal controls the electric power supplied to the Peltier element 12. In this configuration, the temperature of the ultrasonic transducer 11 is controlled so that temperature is in a predetermined temperature range. The properties of the ultrasonic transducer 11 have small temperature dependency. The detection sensitivity to the ultrasonic wave is improved.

### Second Embodiment

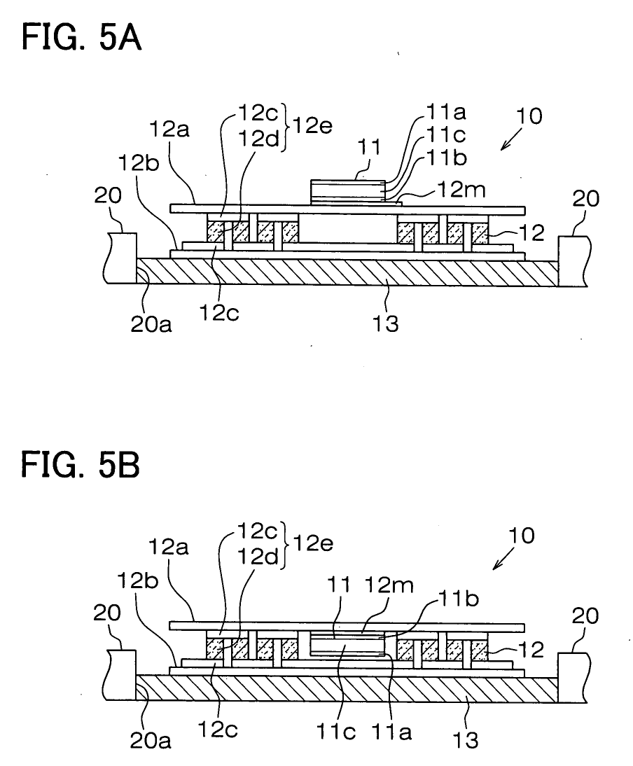

FIGS. 5A and 5B are explanatory diagrams of an ultrasonic sensor according to a second embodiment.

As shown in FIGS. 5A and 5B, one of the main differences between the first embodiment and the second embodiment is that, in the second embodiment, a part of a thermoelectric element 12d is not disposed between the heat release side substrate 12b and the cooling side substrate 12a. The thermoelectric element 12d is disposed in such a manner that it has a rectangular ring shape when viewed from the cooling side substrate 12a. The ultrasonic transducer 11 is disposed on a region of the cooling side substrate 12a, the region which is located over the inside of the rectangular ring. The ultrasonic transducer 11 is disposed on a surface of the cooling side substrate 12a, the surface which is disposed on an outer side of the Peltier element 12, as shown in FIG. 5A. Alternatively, the ultrasonic transducer 11 may be disposed to a surface of the cooling side substrate 12a, the surface which is an inner side of the Peltier element 12, as shown in FIG. 5B.

In these configurations as mentioned above, the thermoelectric element 12d supports the portion of the cooling side substrate, the portion on which the ultrasonic transducer 11 is disposed. The portion of the cooling side substrate 12a has a beam-structure. The structure reduces the stiffness of the portion of the cooling side substrate 12a, and therefore the ultrasonic wave causes the portion to bend largely. The larger bending amplifies the signal output from the ultrasonic transducer 11. The detection sensitivity to the ultrasonic wave is therefore improved.

In an alternative modification of the second embodiment, the ultrasonic transducer 11 is disposed on an opposite side of the vehicle internal side. The ultrasonic transducer 11 is disposed on a surface of the cooling side element 12a, the surface which is disposed on an outer side of the Peltier element 12, as shown in FIG. 5A. The ultrasonic transducer 11 receives the ultrasonic wave without involving the Peltier element 12 and the heat release element 13. Therefore the detection sensitivity to the ultrasonic wave is improved. The cooling side substrate 12a protects the ultrasonic transducer 11, when the ultrasonic transducer 11 is disposed on a surface of the cooling side substrate 12a, the surface which is disposed on an inner side of the Peltier element 12.

The ultrasonic sensor according to the second embodiment includes following advantages.

A portion of the thermoelectric element 12d is not disposed between the heat release side substrate 12b and the portion of the cooling side substrate 12a. The ultrasonic transducer 11 is disposed on the portion of the cooling side substrate 12a. Since the thermoelectric element 12d supports the portion of the cooling side substrate, the portion of the cooling side substrate 12a has a beam-structure. The stiffness of the portion of the cooling side substrate 12a is reduced by the structure. Thus, the portion is easily deformable by the ultrasonic wave. Thus the signal output from the ultrasonic transducer is amplified, and the detection sensitivity of the sensor is improved.

### Third Embodiment

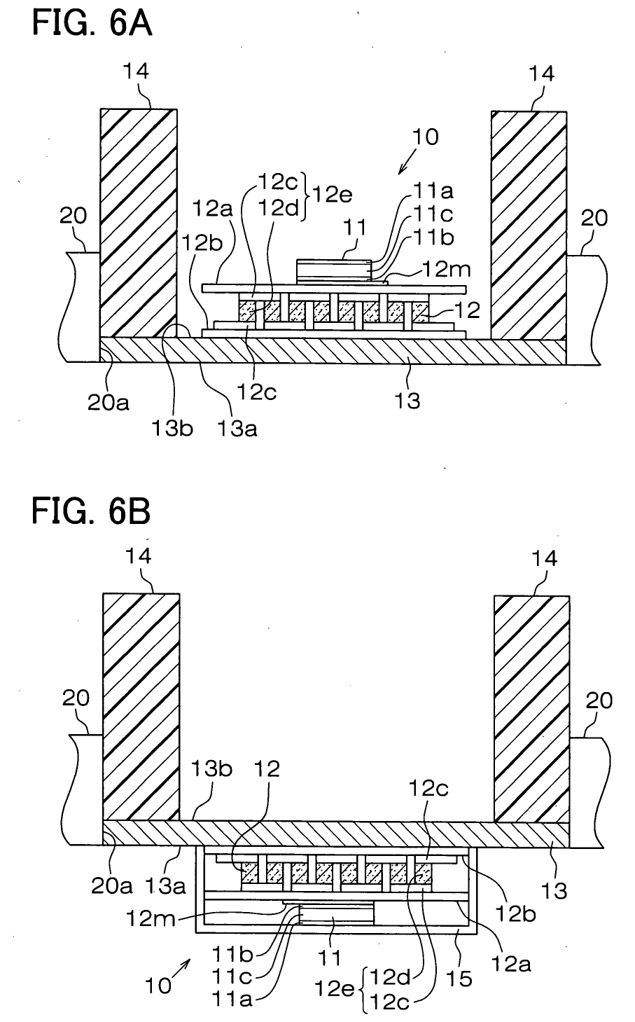

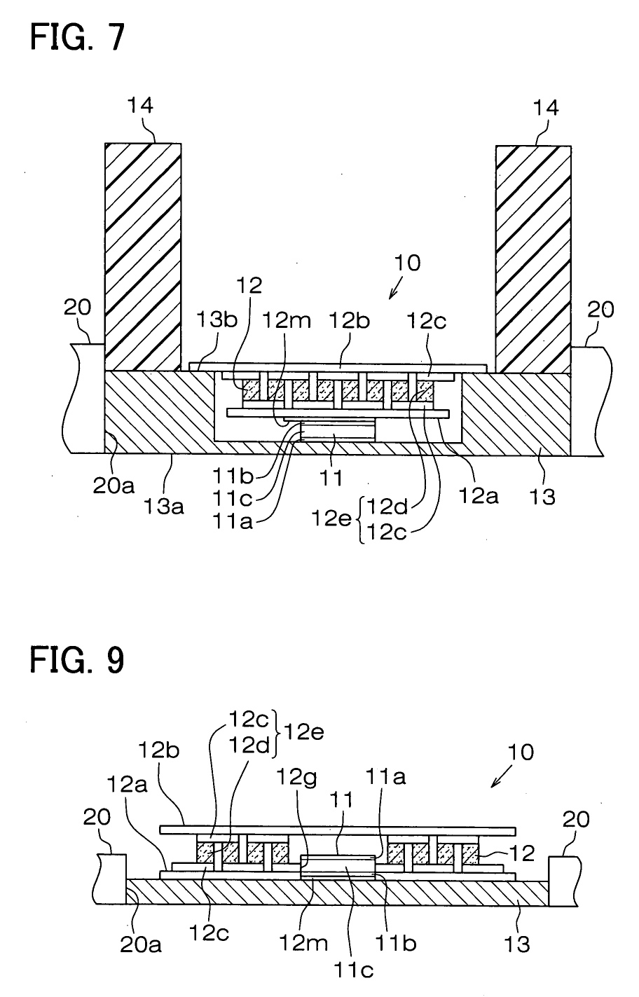

FIGS. 6A, 6B and 7 are an explanatory diagram of an ultrasonic sensor according to a third embodiment.

Main differences between the first embodiment and the third embodiment, which are shown in FIGS. 6A and 6B, are described as follows. The third embodiment includes a mounting member 14 that is deformable in accordance with the ultrasonic sonic wave. The mounting member 14 amplifies the vibration of the heat release element 13. A periphery of the heat release element 13 is coupled with the bumper 20. The heat release element 13 is maintained in a beam-structure.

As shown in FIG. 6A, the ultrasonic transducer 11 is connected to the cooling side substrate 12a. The ultrasonic transducer 11 is disposed on the inner surface 13b side of the heat release element 13. The mounting member 14 is disposed on a periphery of the inner surface 13b of the heat release element 13. The mounting member 14 is almost perpendicular to the inner surface 13b of the heat release element 13. An outer size of the mounting member 14 is larger than that of the fixing portion 20a. The mounting member 14 has a rectangular ring shape when viewed from the ultrasonic transducer 11 side.

The mounting member 14 is made from easily deformable material such as resin. The mounting member 14 is press-fitted to the fixing portion 20a. The mounting member 14 is longer than the width of the bumper 20. The fixing member thus has a free end.

In the configuration as mentioned above, when the heat release element 13 receives the ultrasonic wave, an induced vibration is transmitted to the mounting member 14. A portion around the mounting member 14's end bends repeatedly in the direction almost parallel to the substrate surface. The bending of the mounting member 14 amplifies the vibration of the heat release element 13. The amplified vibration is transmitted to the ultrasonic transducer 11. Therefore the detection sensitivity of the ultrasonic sensor 10 is improved.

An ultrasonic sensor according to a modification of the third embodiment is described as follows. As shown in FIG. 6B, the ultrasonic transducer 11 may be connected to the cooling side substrate 12a. The ultrasonic transducer 11 is disposed on an outer surface 13a side of heat release element 13. Another ultrasonic sensor according to another modification of the third embodiment is described as follows. The heat release element 13 has a concave portion around the center of the heat release element 13, as shown in FIG. 7. The ultrasonic transducer 11 and the Peltier element 12 can be inserted into the concave portion. A periphery of the heat release side substrate 12b is connected to the heat release element 13. In these configurations, the ultrasonic transducer 11 transmits the ultrasonic wave without involving the Peltier element 12. Thus the detection sensitivity to the ultrasonic wave is improved.

The ultrasonic sensor according to the third embodiment includes following advantages.

The mounting member 14 supports the periphery of the heat release element 13. The heat release element 13 has a beam-structure. The ultrasonic sensor 10 is easily mounted to the vehicle with the use of the press-fitting. The sent and received ultrasonic wave deforms the mounting member 14. The resultant repeat deformation of the fixing member amplifies the vibration of the heat release element 13. The vibration of the ultrasonic transducer 11 is amplified. The detection sensitivity of the ultrasonic sensor is improved. When the mounting member 14 is made from resin, the detection sensitivity of the ultrasonic sensor is further improved. This is because the mounting member 14 made from resin is further deformable and the vibration of the heat release element 13 is further amplified.

### Other Embodiments

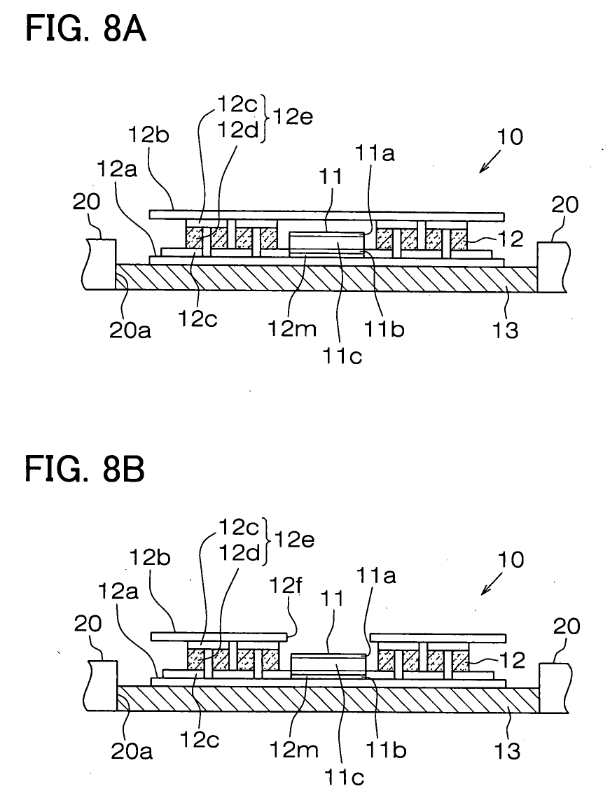

(1) FIG. 8A shows another ultrasonic sensor. The heat release element 13 is disposed on a surface of the cooling side substrate 12a, the surface which is disposed on the outer side of the Peltier element 12. The ultrasonic transducer 11 is disposed on a surface portion of the cooling side substrate 12a, the surface portion which is disposed on the inner side of the Peltier element 12. The thermoelectric element 12d is disposed on the surface portion of the cooling side substrate 12a. In this configuration, the heat in the ultrasonic transducer 11 is transferred to the heat release element 13, and then the heat in the heat release element 13 is radiated to environment due to the function of the Peltier element 12.

FIG. 8B shows further another ultrasonic sensor. The heat release side substrate 12b has a first hole 12f. The first hole 12f is disposed on an opposite side of the ultrasonic transducer 11. This configuration allows the ultrasonic sensor to send and receive the ultrasonic wave without involving an interceptor between the sensor and the obstacle, and hence the pressure of the ultrasonic wave is increased. Therefore the detection sensitivity to the ultrasonic wave is improved.

(2) FIG. 9 shows another ultrasonic sensor. The heat release element 13 is disposed on a surface of the cooling side substrate, the surface which is disposed on the outer side of the Peltier element 12. The cooling side substrate 12a has a second hole 12g. The thermoelectric element 12d is not disposed over the second hole toward the cooling side substrate 12a. The ultrasonic transducer 11 is disposed on the heat release element 13 through the second hole 12g of the cooling side substrate 12a. This configuration allows the heat generated in the ultrasonic transducer 11 to be transferred to the Peltier element. The Peltier element causes the heat to radiate. The cooling performance of the ultrasonic sensor is improved.

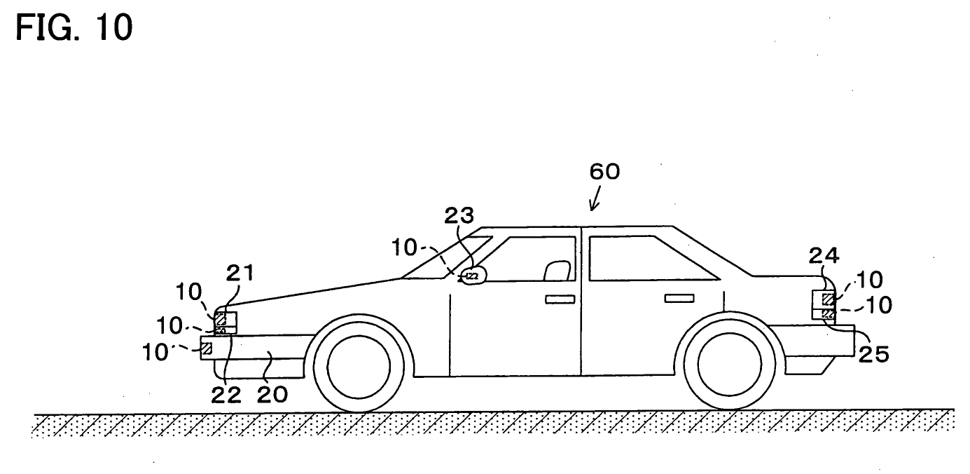

(3) The ultrasonic sensor 10 is mounted to the bumper 20. Alternatively, the sensor 10 may be mounted to another part of the vehicle, as shown in FIG. 10. The sensor is, for example, mounted to a headlamp cover 21. In this configuration, the ultrasonic wave reflected by an obstacle is not intercepted by another part of the vehicle. Thus the reflected ultrasonic wave is reliably detected by the ultrasonic sensor 10. This configuration may be used in applying the ultrasonic sensor 10 to an obstacle sensor. The ultrasonic sensor 10 may be attached to another part of the vehicle according to its use. When the ultrasonic sensor 10 is used for detecting an obstacle being lateral to the vehicle, the sensor 10 is attached to, for example, a blinker cover 22 or a side mirror 23. When the sensor 10 is used for detecting an obstacle behind the vehicle, the sensor 10 is attached to a rear lamp cover 24 or a back-up light cover 25.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An ultrasonic sensor for sending and receiving an ultrasonic wave, the ultrasonic sensor comprising:
an ultrasonic transducer; and
a Peltier element including a thermoelectric element, a first electrode, a first substrate and a second substrate, wherein
the thermoelectric element is coupled with the first electrode,
the thermoelectric element and the first electrode are disposed between the first substrate and the second substrate,
the ultrasonic transducer is disposed on the first substrate, and
the ultrasonic transducer sends and receives the ultrasonic wave in accordance with a vibration of the ultrasonic transducer.

2. The ultrasonic sensor according to claim 1, further comprising:
a heat release element, wherein
the second substrate has a first surface,
the first surface is opposite to thermoelectric element,
the heat release element is disposed on the first surface of the second substrate, and
the heat release element radiates heat, which is transferred from the thermoelectric element.

3. The ultrasonic sensor according to claim 2, further comprising:
a mounting member, wherein
the mounting member supports a periphery of the heat release element in such a manner that the heat release element provide a beam-structure,
the mounting member is coupled with a predetermined apparatus, and
the mounting member is deformable in accordance with the sending and receiving ultrasonic wave so that the vibration of the ultrasonic transducer is amplified.

4. The ultrasonic sensor according to claim 3, wherein
the mounting member is made from resin material.

5. The ultrasonic sensor according to claim 1, further comprising:
a second electrode, wherein
the second electrode is disposed on the first substrate, and
the second electrode is electronically connected to the ultrasonic transducer.

6. The ultrasonic sensor according to claim 1, wherein,
the thermoelectric element is not disposed between the second substrate and a portion of the first substrate, the portion on which the ultrasonic transducer is disposed.

7. The ultrasonic sensor according to claim 1, further comprising:
a temperature detection element; and
a temperature control element, wherein
the temperature detection element is coupled with the ultrasonic transducer and the temperature control element,
the temperature control element is coupled with the Peltier element,
the temperature detection element detects a temperature of the ultrasonic transducer, and
the temperature control element controls an electronic power to be supplied to the Peltier element based on a temperature signal output from the temperature detection element, and controls the temperature of the ultrasonic transducer.

8. The ultrasonic sensor according to claim 1, further comprising:
a heat release element, wherein
the thermoelectric element is disposed between the first substrate and the second substrate in such a manner that the thermoelectric element has a ring structure,
the first substrate includes a second surface and a third surface,
the third surface of the first substrate is opposite to the thermoelectric element,
the second surface of the first substrate is opposite to the third surface,
the heat release element is disposed on the third surface of the first substrate,
the ultrasonic transducer is disposed on the second surface of the first substrate in such a way that the ring structure of the thermoelectric element surrounds the ultrasonic transducer, and
the heat release element absorbs heat generated in the ultrasonic transducer.

9. The ultrasonic sensor according to claim 8, wherein,
the second substrate has an first opening at a predetermined place,
the second substrate is opposite to the heat release element with respect to the ultrasonic transducer.

10. The ultrasonic sensor according to claim 1, wherein
The first substrate provides a cooling side substrate, on which the ultrasonic transducer for being cooled is disposed,
The second substrate provides a heat release side substrate, on which the heat release element is disposed, the heat release element which radiates heat generated in the ultrasonic transducer, and
The first electrode has a pair of electrode surfaces, which contact the cooling side substrate and the heat release side substrate, respectively.

11. The ultrasonic sensor according to claim 1, wherein
the ultrasonic sensor is mounted to at least one part of a vehicle, the one part which is selected from the group consisting of a headlamp cover, a rear lamp cover, a blinker cover, a back-up light cover, a side mirror and a bumper.

12. An ultrasonic sensor for sending and receiving an ultrasonic wave, the ultrasonic sensor comprising:
an ultrasonic transducer;
a Peltier element including a thermoelectric element, a first electrode, a first substrate and the second substrate; and
a heat release element, wherein
the first substrate has a second opening at a predetermined portion,
the thermoelectric element is coupled with the first electrode,
the first electrode and the thermoelectric element are disposed between the first substrate except the second opening and the second substrate,
the first substrate has a third surface,
the third surface is opposite to the thermoelectric element,
the heat release element is disposed on the third surface of the first substrate,
the heat release element has a fourth surface on which the first substrate is disposed,
the ultrasonic transducer is disposed on the fourth surface of the heat release element, and disposed in the second opening of the first substrate,
the ultrasonic transducer sends and receives the ultrasonic wave, and
the heat release element absorbs heat generated in the ultrasonic transducer.
